(19) United States
(12) Patent Application Publication
(10) Pub. No.: US 2003/0234086 A1
(43) Pub. Date: Dec. 25, 2003

(54) Process for accelerated evaporation of large quantities of liquid - such as septic tank effluent

(76) Inventor: Isaac W. Sirbaugh, Hague, VA (US)

Correspondence Address: Isaac W. Sirbaugh, 545 Wilton Woods Drive, Hague, VA, 22469, US

(21) Appl. No.: 10/122,358

(22) Filed: Jun. 24, 2002

(51) Int. Cl. B01D 1/00

(52) U.S. Cl. 159/22; 159/905

(57) ABSTRACT

Recently developed proceedures refine home septic tank effluent to a clean, odorless liquid, but the problem of daily disposal of hundreds of gallons of efflluent remains. Currently this fluid is emptied into the soil, a stream, or slow-evaporation ponds. Frequently, none of these methods are possible at an otherwise desirable homesite. Therefore, a compact, relatively inexpensive, and above all, quick acting process is needed. My process consists of four steps:

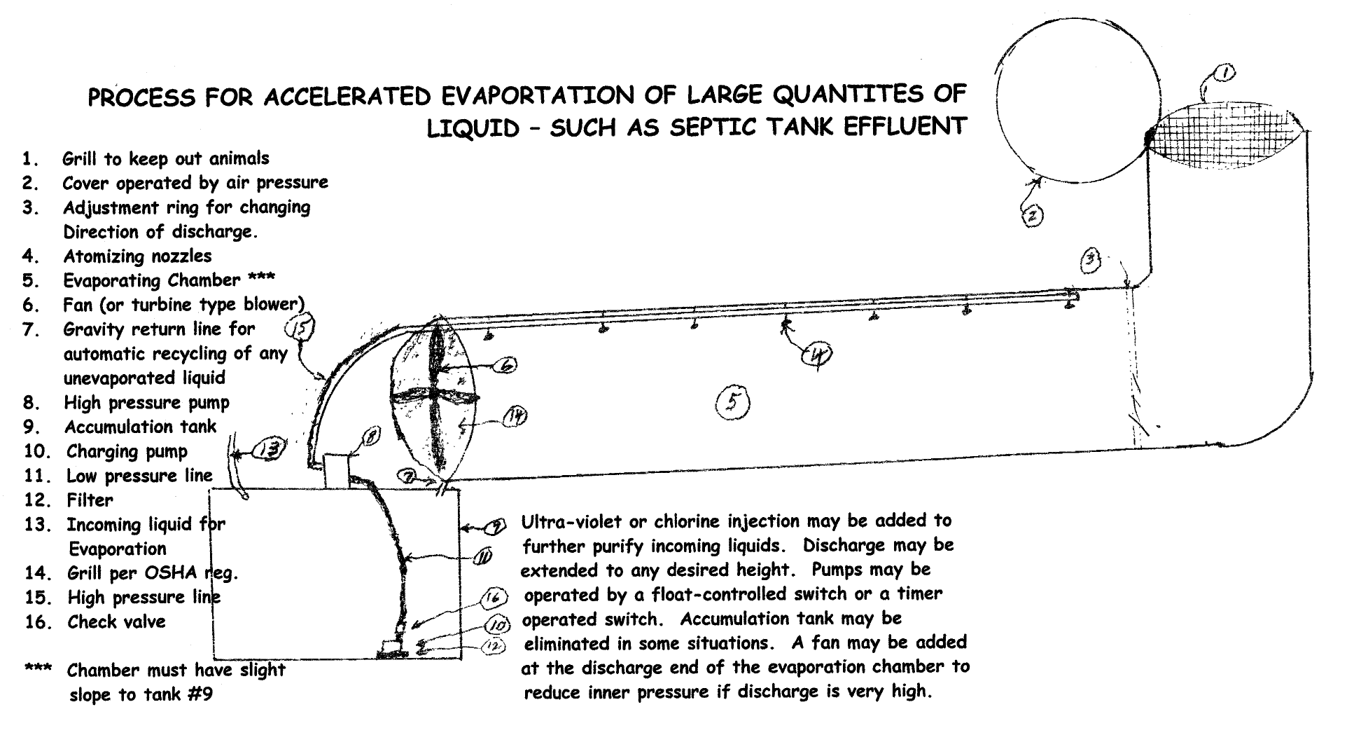

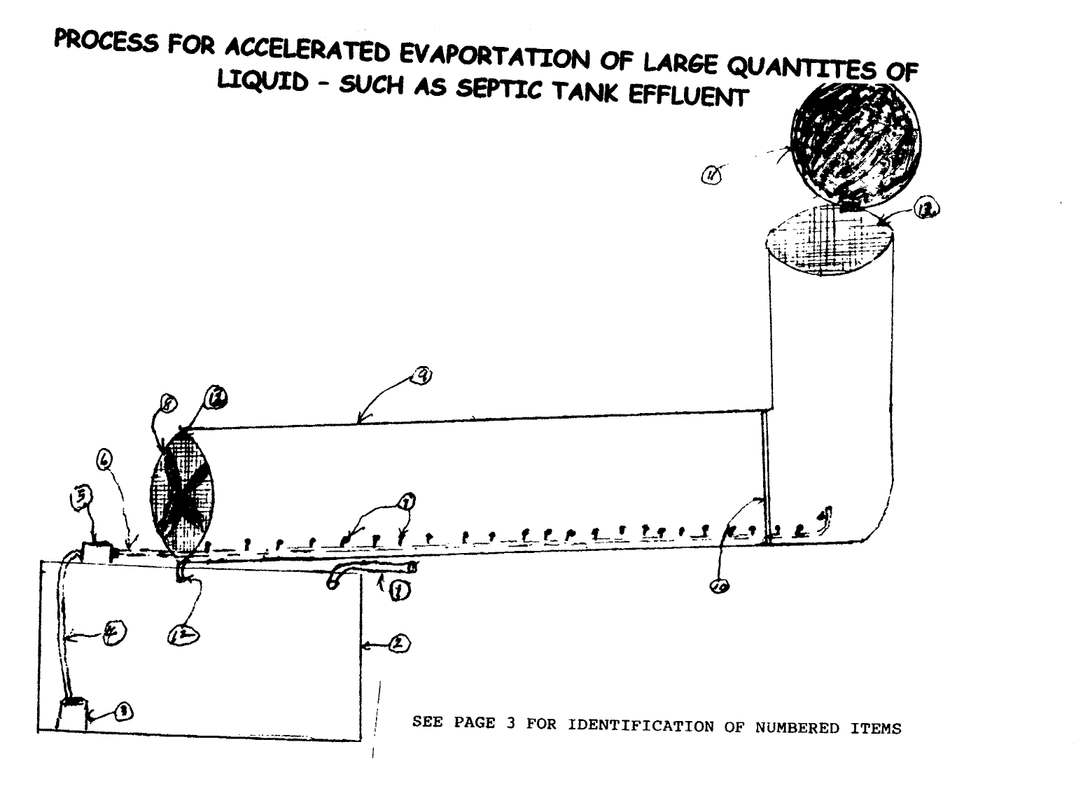

1. Create a very large fluid surface area by reducing the liquid to very small droplets.

2. Expose this surface to large volumes of rapidly moving air.

3. Maintain the moving air and diffused liquid in contact until evaporation occurs.

4. Return the humid air to the atmosphere quietly, and in any desired direction.

A system (see example on page 2) using my process can easily be sized to evaporate the daily effluent from an average household within 4 hours or less running time.

I, Isaac W. Sirbaugh, claim that the process outlined below constitutes a first and original invention and that I am the sole inventor of the method of acceleration of evaporation of large quantities (hundreds of gallons per day) of liquid. I further claim that this process will make possible the utilization of many home sites which cannot now be developed because of difficulties in disposal of septic tank effluent. Further, there will often be other advantages, both financial and esoteric because of reduced site preparation, e.g., no tree removal, no perculation ditches, only about 100 square feet of space used.

The process consists of (a) creation of a very large surface area of liquid by atomization, (b) exposing this surface to large quantities of rapidly moving air, (c) accomplishing steps (a) and (b) in relatively small tightly enclosed space, and (d) returning the humid air to the general atmosphere with a minimum of disturbance.

A system to implement the above process is shown on the drawing (page 2 substitute). This system is designed primarily for disposal of treated effluent from home septic tanks or small commercial establishhments.It will make possible construction of homes in areas where effluent cannot be released to the soil or into the water of streams or into lagoons or special fields for slow evaporation.

### EXPLANATION OF DRAWING

There follows an explanation of identification numbers used on the drawing, (Page 2, Substitute). The numbers are arranged in order from the beginning of the process.

1. Incoming fluid line

2. Accumulation tank

3. Low pressure charging pump with filter

4. Low pressure feed line

5. High pressure pump

6. High pressure line to atomizing nozzles

7. Atomizing nozzles

8. High volume fan or blower

9. Evaporating chamber

10. Slip ring to adjust direction of discharge

11. Lid (operated by air pressure)

12. Gravity return line for automatic recycling of any unevaporated liquid

13. Wire grills

### OPTIONS TO MEET SPECIAL NEEDS

Ultra-violet light or chlorine injection may be added to further purify incoming liquids.

Discharge point may be raised to any desired height.

Pumps may be controlled by a float operated switch or by a switch with timer.

High humidity or low temperature may be overcome by heating the air before it enters the evaporation chamber.

It will generally be expedient to enclose the pumps and blower in a tool shed for protection from weather, insects, and vermin.

1. What I claim as my invention is a process to quickly and economically evaporate large quantities of non-toxic liquids, e.g. treated septic tank effluent

2. I claim that my process will be very useful in disposing of liquids which for various reasons, cannot be released to the soil or into streams. The principles of the process are explained in the Abstract (page 4) and are illustrated by a drawing (page 2, substitute).
